(19) United States
(12) Patent Application Publication
(10) Pub. No.: US 2016/0085568 A1
(43) Pub. Date: Mar. 24, 2016

(54) HYBRID VIRTUALIZATION METHOD FOR INTERRUPT CONTROLLER IN NESTED VIRTUALIZATION ENVIRONMENT

(71) Applicant: ELECTRONICS AND TELECOMMUNICATIONS RESEARCH INSTITUTE, Daejeon (KR)

(72) Inventors: Vincent DUPRE, Daejeon (KR); Tae-Ho KIM, Gyeonggi-do (KR); Chae-Deok LIM, Daejeon (KR)

(21) Appl. No.: 14/825,409

(22) Filed: Aug. 13, 2015

(30) Foreign Application Priority Data
Sep. 18, 2014 (KR) 10-2014-0124529

(51) Int. Cl. G06F 9/455; G06F 9/48

(52) U.S. Cl. CPC G06F 9/45533; G06F 9/4812; G06F 2009/45579

(57) ABSTRACT

Disclosed is a hybrid virtualization method for an interrupt controller in nested virtualized environment, which can reduce guest interrupt latency. A hybrid virtualization method includes operating a Virtual Machine Manager (VMM) which enables a program executed on a host and a program executed on a guest to be simultaneously used, providing, by the VMM, a virtual interrupt configuration register to the guest, and selectively utilizing full virtualization and partial virtualization. Full virtualization is used when guests which are running simultaneously request the same interrupt. In this case, the interrupt is trapped by the VMM before being injected to the different guests. Partial virtualization allows a guest to directly handle incoming interrupt and avoids expensive traps to the hypervisor to reduce the latency. This virtualization technique can be used by any kind of VMM which is physical hypervisor or virtual hypervisor for processing interrupts of their respective guests.

### CROSS REFERENCE TO RELATED APPLICATION

This application claims the benefit of Korean Patent Application No. 10-2014-0124529, filed Sep. 18, 2014, which is hereby incorporated by reference in its entirety into this application.

### BACKGROUND OF THE INVENTION

1. Technical Field

The present invention generally relates to a hybrid virtualization method for an interrupt controller and, more particularly, to a method that reduces interrupt latency via hybrid virtualization including full virtualization and partial virtualization.

2. Description of the Related Art

An interrupt is a signal for temporarily stopping a program that is currently being executed and for inserting and executing another program. Further, an interrupt refers to a scheme in which when a condition meeting an interrupt factor is produced, a program currently being executed is stopped, control is compulsorily shifted to a specific address, and a prepared interrupt processing program is executed, and in which, after the processing program has been terminated, the process returns to an original program and resumes the execution of the original program.

Such an interrupt may contribute to an increase in the efficiency of program processing and the efficiency of online processing of simultaneous operations in an input/output (I/O) device. The types of interrupt factors include an I/O termination interrupt, a program interrupt, a monitoring program call interrupt, a failure interrupt, etc.

The features of interrupt processing are described as follows.

An interrupt is managed to allocate an Interrupt Request (IRQ) number. When a process senses that an interrupt has been generated in response to an IRQ, the process stops a task currently being executed and calls an Interrupt Service Routine (ISR) in interrupt context.

Since an interrupt is a high-priority task, which is executed while stopping another task, it has limitations appropriate thereto.

In an interrupt context, sleep code is unavailable.

An interrupt task cannot directly exchange data with a user area.

An interrupt requires the processing of a fast and perfect task so as not to interfere with other tasks.

A processor having priority higher than that of a current processor and relating to an IRQ may cause an interrupt.

Meanwhile, in a recent computing environment, the term “virtualization” is frequently used, which refers to technology for logically integrating physically different systems or for, on the contrary, logically partitioning a single system, thus enabling resources to be efficiently utilized. By way of this technology, it is possible to connect and use different types of servers and storage devices and to simultaneously process different types of tasks in a single system without causing interference between the tasks, via the partitioning of the system.

Such virtualization is implemented by a Virtual Machine (VM).

A virtual machine refers to a software container composed of operating systems and application programs that are running on a physical computer.

A single virtual machine is executed like a physical computer, and has virtual resources, that is, a virtual Central Processing Unit (vCPU), virtual memory (vMem), a virtual disk (vDisk), a virtual Network Interface Card (vNIC), etc. Therefore, an operating system, an application or the network of another computer does not recognize a difference between a virtual machine and a physical device. In addition, since the virtual machine is implemented using software that does not have any hardware components, it has several advantages superior to physical hardware.

For example, two or more operating programs may be simultaneously executed on the same machine via virtualization. For operating programs, access to a physical machine is controlled, and thus the operating programs are prevented from being interfered with.

Generally, the virtualization of a processor or a computer system may include the step of providing access to a virtual machine completely controlled by an operating program to one or more operating programs, but the control of a physical machine is performed by a Virtual Machine Manager (VMM).

The components of a virtual machine may be implemented using hardware allocated, at least temporarily, by a VMM to the virtual machine, or may be emulated using software. Each operating program may be called a “guest”.

Virtualization may be implemented using software on a physical machine that is executed by a VMM and a related virtual machine, without the support of specific hardware virtualization.

The primary problem appearing in virtualization is the latency of interrupt transmission. As described above, peripheral devices may be allocated to be used by a virtual machine. Such a peripheral device may generate interrupts to be processed by the software of the virtual machine. In a non-virtualization environment, interrupt processing latency may be relatively short. In the virtualization environment, an interrupt is generally intercepted by a VMM, is processed by the VMM, and is then transferred to a target virtual machine by the VMM using some kinds of software mechanisms.

A ‘trap-and-emulate’ method that is a conventional virtualization method involves the hardware trapping individual virtualization instructions issued by a guest hypervisor and having the root-mode hypervisor emulate their behavior.

However, a problem arises in that the high frequency of virtualization instructions in critical code paths can make this mechanism prohibitively slow.

Virtualization techniques can be used also for hypervisor and is called nested virtualization.

In some case, hypervisor may be itself subjected to virtualization. This case is known as nested virtualization. Virtualization latencies are therefore amplified in nested virtualized environment.

Korean Patent Application Publication No. 10-2014-0054349 entitled “Virtualization Processing Method and Apparatuses, and Computer System” discloses characteristics related to the performance optimization and compatibility of a virtualization system, but this patent does not solve interrupt latency caused by the above-described ‘trap-and-emulate’. Additionally, U.S. Pat. No. 8,490,090 B2 discloses a technology related to “Multilevel Support in a Nested Virtualization Environment” and U.S. Pat. No. 8,458,698 B2 discloses a technology related to “Improving Performance in a Nested Virtualized Environment.”

### SUMMARY OF THE INVENTION

Accordingly, the present invention has been made keeping in mind the above problems occurring in the prior art, and an object of the present invention is to reduce interrupt latency using a hybrid virtualization method.

Other objects of the present invention will be easily understood from the description of the following embodiments.

In accordance with an aspect of the present invention to accomplish the above object, there is provided a hybrid virtualization method for an interrupt controller, including operating a Virtual Machine Manager (VMM) that enables a program executed on a host and a program executed on a guest to be simultaneously used; providing, by the VMM, a virtual interrupt configuration register to the guest; and selectively utilizing full virtualization and partial virtualization.

The host may be an operating system running on actual physical hardware and the guest is an operating system running on a Virtual Machine (VM). Selectively utilizing the full virtualization and the partial virtualization may include determining whether an operation that is currently performed is either an operation to be performed by the host or an operation is to be performed by the guest.

Determining whether the operation that is currently performed is either the operation to be performed by the host or the operation to be performed by the guest may include determining whether a currently occurring interrupt is an interrupt occurring on the host or is an interrupt occurring on the guest.

The hybrid virtualization method (partial virtualization) allows a guest to handle interrupt without the intervention of the VMM and thus reduces the interrupt latency. The hybrid virtualization method (full virtualization) further include when multiple guests are operated in parallel and an identical interrupt occurs, the interrupt is signaled to the VMM in host mode before being injected to the different guest.

The hybrid virtualization method may further include, when an interrupt for the host occurs, stopping all programs that are currently operating, and controlling the interrupt so that the interrupt is executed in a host mode.

The hybrid virtualization method may be used in nested virtualization environment.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram showing hybrid virtualization for an interrupt controller according to an embodiment of the present invention in a classic virtualized environment;

FIG. 2 is a diagram showing a general concept of CPU modes in a nested virtualized environment.

FIG. 3 is a diagram showing a hierarchy of CPU modes in a nested virtualized environment.

FIG. 4 is a diagram showing hybrid interrupt virtualization scheme in a nested virtualized environment.

FIG. 5 is a flowchart showing trapping access to the interrupt configuration register.

FIG. 6 is a flowchart with regard to processing a physical IRQ.

FIG. 7 is a flowchart with regard to processing a virtual IRQ.

FIG. 8 is a flowchart with regard to injecting a virtual IRQ.

### DESCRIPTION OF THE PREFERRED EMBODIMENTS

The present invention may be variously changed and may have various embodiments, and specific embodiments will be described in detail below with reference to the attached drawings. However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context.

Hereinafter, embodiments of the present invention will be described in detail with reference to the attached drawings.

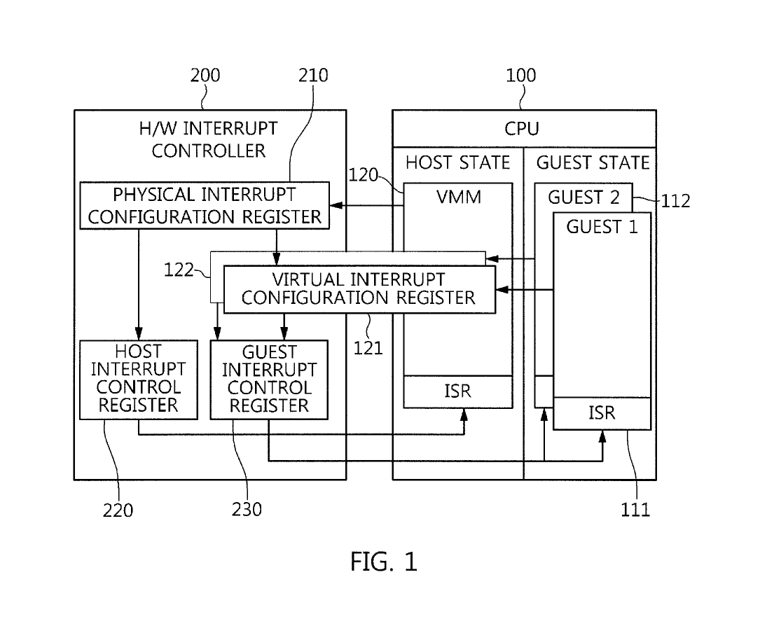

FIG. 1 is a configuration diagram showing hybrid virtualization for an interrupt controller according to an embodiment of the present invention.

A central processing unit (CPU) 100 for virtualization may be operated to be separated into a host state in which software (especially an operating system) can directly control hardware and a guest state in which hardware is controlled based on software with the help of a Virtual Machine Manager (VMM) 120.

Here, the host state and the guest state respectively denote a state in which the CPU is operated in a host mode and a state in which the CPU is operated in a guest mode.

In this regard, a host denotes an Operating System (OS) running on actual physical hardware and a guest denotes an OS running on a VM.

In the present invention, the interrupt controller (IC) is divided in two set of registers. The configuration register is used to configure different interrupts such as enabling or disabling a specific IRQ, setting a state of an IRQ (pending or active, etc.) and setting the priority. The control register is used for transferring interrupts to the CPU and managing the life-cycle of an interrupt such as acknowledgement and signaling the end of an interrupt.

When an interrupt is signaled to the IC, the configuration register updates the state of the corresponding IRQ to pending. If the IRQ is enabled in the configuration register, then the IRQ is signaled to the CPU. The running program on the CPU is pre-empted and the CPU branches to the ISR. The ISR accesses the control register of the IC to acknowledge and end the IRQ. When the state of an IRQ is modified through the control register, its state in the configuration register is also updated.

For supporting virtualization, the present invention introduces the virtual interrupt configuration register and separated interrupt control register. The virtual interrupt configuration register (VICR) may be seen as a subset of the physical interrupt configuration register (PICR). The VICR is controlled by the host (i.e. VMM) and each time guests access the VICR, a trap to the hypervisor is triggered. In the PICR, the host can define an interrupt as a host interrupt or a guest interrupt.

The separate interrupt control register is used to generate exception in CPU host mode or CPU guest mode. If a pending interrupt is forwarded to the host interrupt control register (HICR), the CPU branches to the ISR in host mode. If a pending interrupt is forwarded to the guest interrupt control register (GICR), the CPU branches to the ISR in guest mode. Therefore, an interrupt can be configured as a guest interrupt (forwardable to GICR) or a host interrupt (forwardable to HICR). The host or guest interrupt is configured through the PICR.

Moreover, the VICR is an emulation of the physical configuration register to hide the real/physical configuration of interrupts to the guests: each time a guest accesses its virtual interrupt configuration register, the access is trapped and emulated by the host in function of the physical configuration register.

Knowing the type of an interrupt and when an interrupt is raised, the interrupt is automatically transferred to the guest interrupt control register if the interrupt is a guest interrupt and redirected the host if it is a host interrupt. This case is called “Partial Virtualization” as only the configuration register is virtualized and the guest is able to control directly the lifecycle of the pending interrupt through the guest interrupt control register. That is, an interrupt request by a guest is directly handled by the guest.

When the same interrupt is configured by more than one guest through the virtual configuration registers, the interrupt may be reconfigured as a host interrupt. This interrupt will be firstly caught by the host and then, reinjected to the different guests through the configuration register. This case is called “Full Virtualization” as the configuration register is virtualized and an interrupt request by several guests is firstly trapped by the host before being injected to the different guests.

In detail, in full virtualization, an interrupt requested by the guest is firstly trapped by the hypervisor before being injected to the guest. In this case, the interrupt is configured as a host interrupt. When the interrupt is pending, the PICR transfers the IRQ to the HICR as it is a host IRQ. Then, the CPU switches to the host ISR of the VMM. The VMM may decide to inject this IRQ to different guests by accessing the VICR and changing the state of the corresponding IRQ. In response to the IRQ state change, the VICR transfers the virtual IRQ to the GICR which in turn generates a guest exception and makes the CPU switch to guest mode for handling the virtual interrupt. This method is particularly useful when several guests request the same interrupt. However, it generates a trap to the VMM which may be avoided when a single guest is requested an interrupt.

Contrary to the full virtualization, the partial virtualization allows a guest to directly handle a physical interrupt. First, the interrupt may be configured as a guest interrupt by the host in response to an access to the VICR. When a physical interrupt is pending, if the interrupt is configured as a guest interrupt, the interrupt is forwarded to the GICR and a guest interrupt exception is signaled to the CPU. After that, the CPU switches to guest mode and jumps to the guest ISR.

The present invention is characterized in that full virtualization and partial virtualization may be selectively used When using the partial virtualization, the latency is reduced because interrupts requested by the guest are directly handled by the guest. When a description is made with reference to FIG. 1 by way of example, the VMM 120 accesses the physical interrupt configuration register 210, and executes an Interrupt Service Routine (ISR) via a host interrupt control register 220. Further, the VMM 120 provides respectively guests 111 and 112 with interrupt virtual configuration register 121 and 122 and executes an ISR via the guest interrupt control register 230 In this case, the IRQ is processed through the guest interrupt control register and configured through the virtual interrupt configuration register.

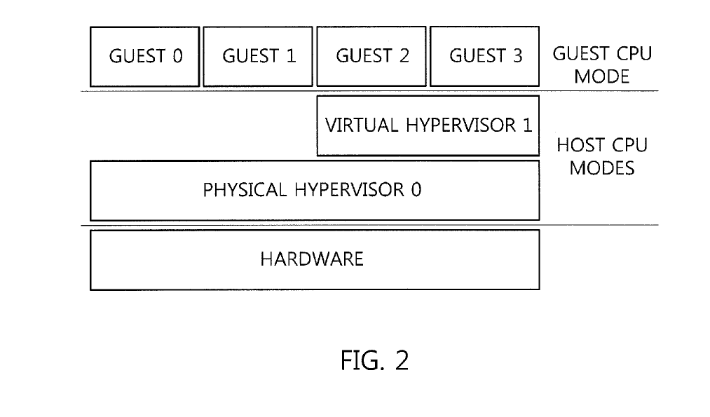

FIG. 2 is a diagram showing a general concept of CPU modes in a nested virtualized environment.

In a nested virtualized environment, a virtual VMM is able to run on the top of a physical VMM. Referring to FIG. 2, the physical hypervisor 0 manages Guest 0 and Guest 1 as guest OS and virtual hypervisor 1 as a guest hypervisor. The guest hypervisor 1 manages Guest 2 and Guest 3 as guest OS.

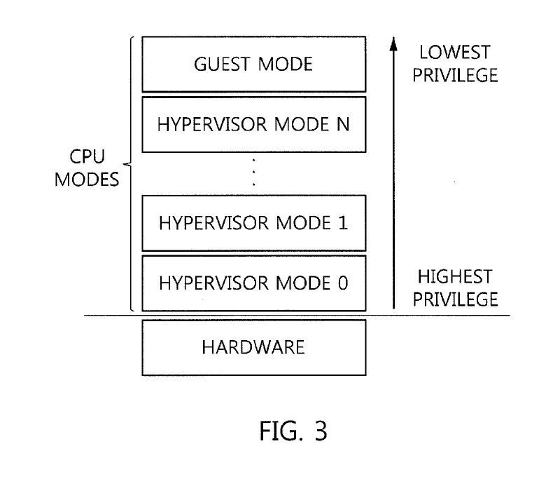

FIG. 3 is a diagram showing a hierarchy of CPU modes in a nested virtualized environment.

Referring to FIG. 2 and FIG. 3, all guest OS are running in the same CPU mode (guest mode) while VMM hypervisor 0 and hypervisor 1 are running in host mode but with different privilege level. In case of nested virtualization with at most N+1 VMM, the VMM running in hypervisor 0 mode has the highest privilege and is called the physical VMM as it has access to the hardware. VMM running in hypervisor 1 to hypervisor N mode are virtual VMM. There is also a hierarchy in the privilege for the virtual VMM. The VMM running in hypervisor 1 mode has the highest privilege than VMM running in hypervisor 2 mode. The VMM running in hypervisor mode 2 has highest privilege than the VMM running in hypervisor mode 3 and so on. VMM running in hypervisor mode N has the lowest privilege comparing to other hypervisor modes.

Highest privilege may signify that CPU mode switch triggered by an exception is delayed until the current CPU mode has same privilege or lower privilege than the CPU mode of the exception.

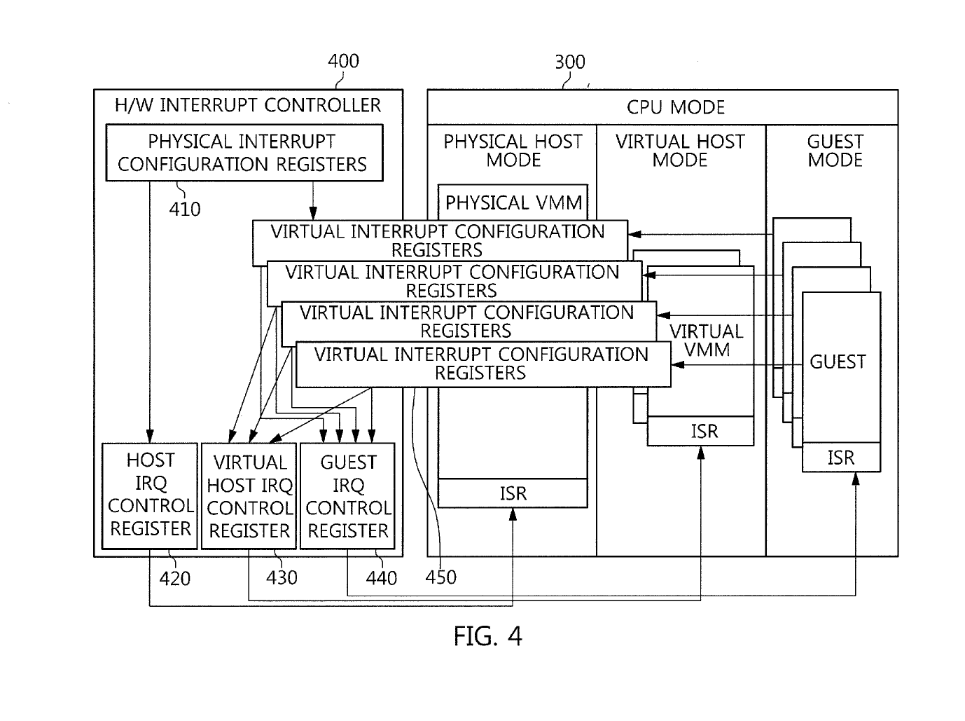

FIG. 4 is a diagram showing hybrid interrupt virtualization scheme in a nested virtualized environment.

Referring to FIG. 4, the VMM running in virtual hypervisor modes receives and controls its IRQ from the Virtual Host IRQ control register 430. The virtual configuration register managed by the virtual hypervisor can configure an interrupt as a virtual host interrupt or a guest interrupt. Also, each guest's access to the interrupt configuration register is trapped by the hypervisor that has configured the guest. Similarly, virtual hosts that are accessing the interrupt configuration register trapped by either another virtual host or a physical host. A recursive trap and emulate operation may happen until the access is handled by the physical host. A interrupt can be configured by the physical VMM through the physical interrupt configuration register (PICR) 410 as a host IRQ or a virtual IRQ. If the IRQ is configured as a host IRQ, then the IRQ is transferred to the host IRQ control register (HICR) 420 when interrupt is signaled to the IC 400. If the IRQ is configured as a virtual IRQ, then the IRQ is transferred either to the virtual host IRQ control register (VHICR) 430 or to the guest IRQ control register (GICR) 440 when interrupt is signaled to the IC 400. A virtual interrupt can be configured by the virtual VMM as a virtual host IRQ or a guest IRQ through the virtual interrupt configuration register (VICR) 450. If the virtual IRQ is configured as a guest IRQ, then the IRQ is transferred to the GICR 440. If the virtual IRQ is configured as virtual host IRQ, then the IRQ is transferred to the VHICR 430.

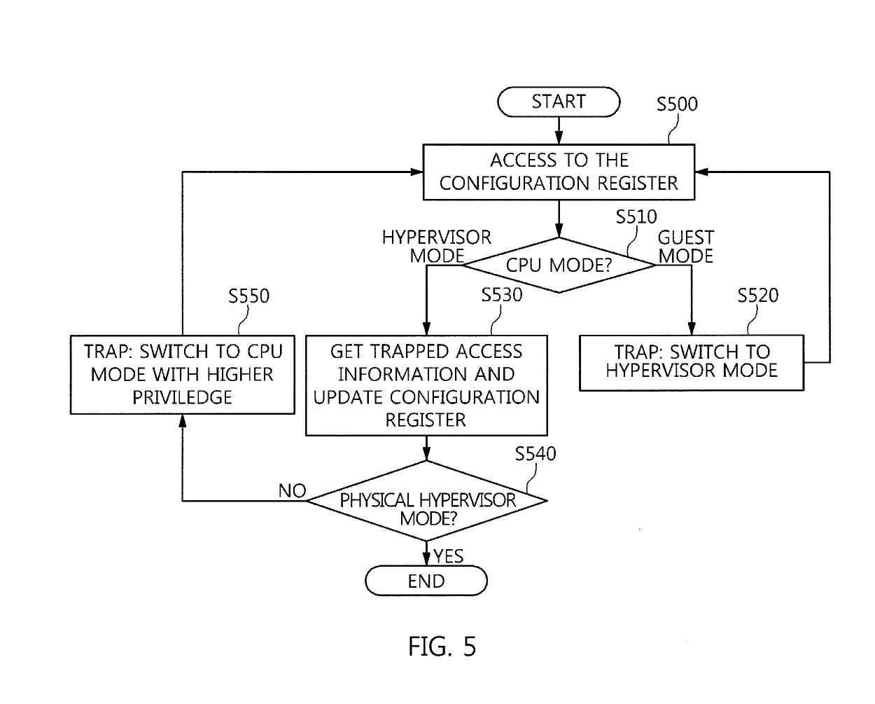

FIG. 5 is a flowchart showing trapping access to the interrupt configuration register.

Only software running in hypervisor 0 mode (highest privileged mode) can access the physical interrupt configuration register. When an access (read or write) to the interrupt configuration register is executed at step S500, the CPU mode of the current program is verified at step S510. If the program is running in a guest mode, then a trap is generated and the CPU switches to the hypervisor mode from which the guest has been initialized at step S520. If the host mode trapped access to the configuration register, then the trapped access is decoded (read or write access/which register and value) as step S530. If during emulation, the configuration register is accessed and the CPU mode is not the physical hypervisor mode (most privileged mode), then the access is trapped and CPU switches to the hypervisor mode from which the virtual hypervisor has been configured at step S540 and S550. This process is executed until the physical hypervisor running in physical hypervisor mode traps and emulates the access to the configuration register.

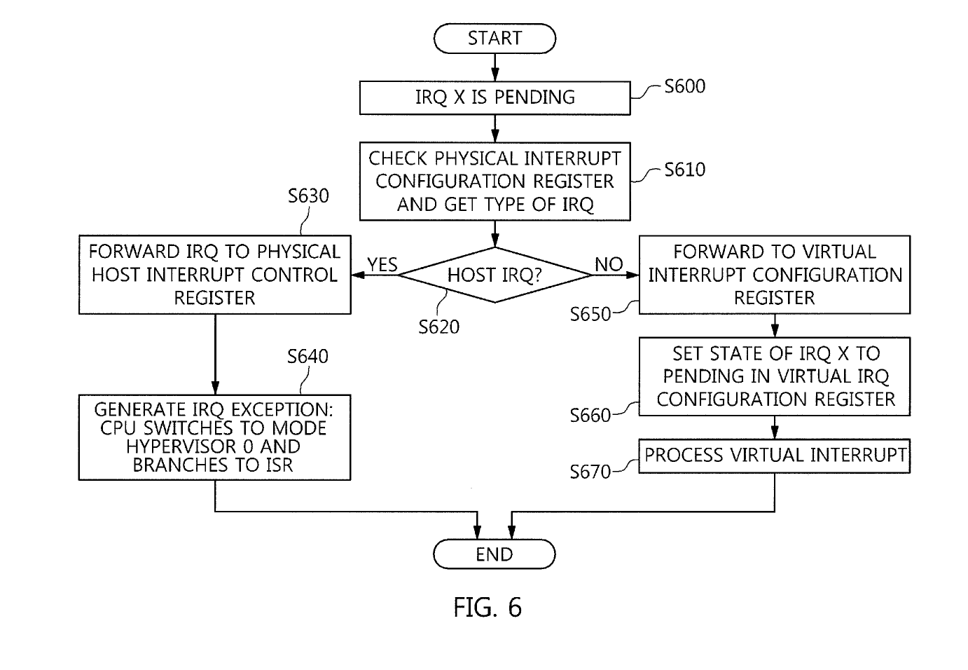

FIG. 6 is a flowchart with regard to processing a physical IRQ.

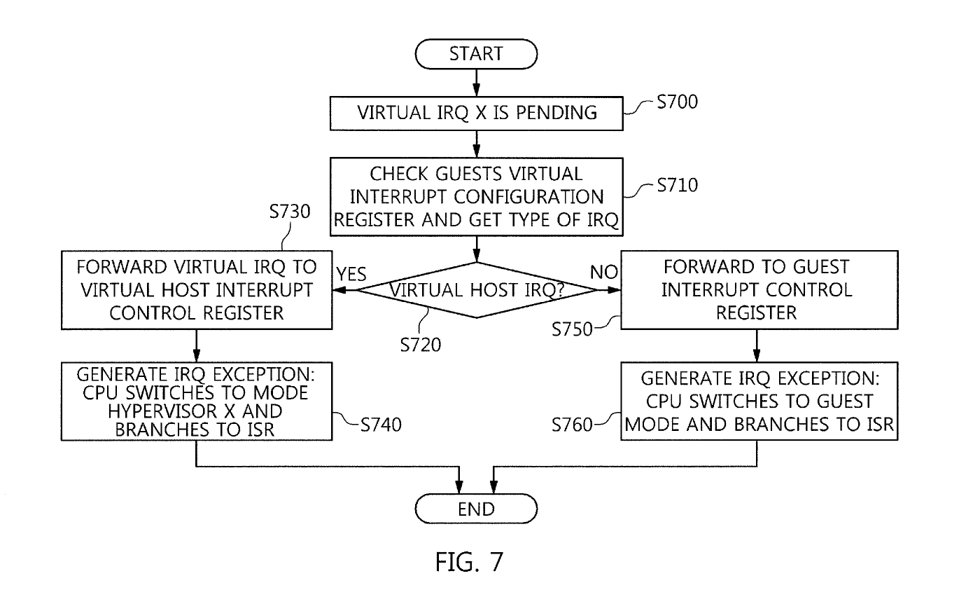

FIG. 6 illustrates how the hybrid virtualization scheme processes a pending physical interrupt. A physical interrupt is configured as a host interrupt or a virtual interrupt in the PICR. When a host interrupt is pending at step S600, the physical interrupt configuration register is checked and the type of the IRQ is obtained at step S610. If the IRQ is a host IRQ, the interrupt is forwarded to the HICR and generates an IRQ exception in hypervisor mode 0 at step S630 and S640. If the IRQ is not a host IRQ, the interrupt is forwarded to the virtual interrupt configuration register at step S650, the state of IRQ x is set to pending in the virtual IRQ configuration register at step S660, and then the virtual interrupt is processed at step S670. The virtual interrupt is processed as explained in FIG. 7.

FIG. 7 is a flowchart with regard to processing a virtual IRQ.

FIG. 7 illustrates how virtual IRQs are processed. The process is very similar to the process of a physical interrupt. When a virtual interrupt is pending at step S700, the guest virtual interrupt configuration register is checked and the type of the IRQ is obtained at step S710. If the IRQ is a virtual host IRQ, the virtual IRQ is forwarded to the VHICR at step S730 and an IRQ exception is signaled to the processor: the CPU switches to mode hypervisor x and branches to the virtual host ISR at step S740. If the IRQ is not a virtual host IRQ, the virtual IRQ is forwarded to the GICR at step S750 and an IRQ exception which means that the CPU switches to guest mode and branches to ISR is generated at step S760.

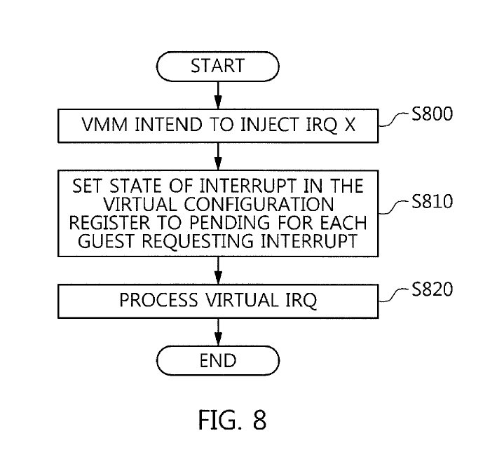

FIG. 8 is a flowchart with regard to injecting a virtual IRQ.

The physical hypervisor or the virtual hypervisor may need to inject a virtual interrupt to a guest or a virtual hypervisor. Referring to FIG. 8, if the VMM intends to inject IRQ x at step S800, the state of the interrupt in the virtual configuration register is set to pending for each guest requesting the interrupt at step S810, and then the virtual IRQ is processed at step S820 which is illustrated by FIG. 7.

The present invention is advantageous in that, when an interrupt occurs, each guest or virtual hypervisor may directly service an interrupt, thus reducing interrupt latency.

Although the present invention has been described with reference to the embodiments of the present invention, those skilled in the art will appreciate that various changes and modifications are possible, without departing from the scope and spirit of the invention as disclosed in the accompanying claims.

What is claimed is:

1. A hybrid virtualization apparatus for an interrupt controller (IC) in a nested virtualization environment, the apparatus comprising:
a physical interrupt configuration register (PICR) for configuring a physical interrupt; and
a virtual interrupt configuration register (VICR) for configuring a virtual interrupt.

2. The apparatus of claim 1, further comprising:
a host interrupt control register (HICR) for controlling a life-cycle of a host interrupt;
a guest interrupt control register (GICR) for controlling a life-cycle of a virtual guest interrupt; and
a virtual host interrupt control register (VHICR) for controlling a life-cycle of a virtual host interrupt.

3. The apparatus of claim 2, wherein the PICR or VICR uses a trap and emulate method.

4. The apparatus of claim 3, wherein accessing the PICR or VICR is recursively trapped in a host mode from which a guest or a virtual host has been configured until the host mode 0 which means a physical hypervisor trapped the access.

5. The apparatus of claim 4, wherein the PICR configures the host interrupt or a guest interrupt.

6. The apparatus of claim 5, wherein the host interrupt is handled in the host mode 0.

7. The apparatus of claim 6, wherein the guest interrupt is configured as the virtual host interrupt or the virtual guest interrupt in the VICR.

8. The apparatus of claim 7, wherein the virtual guest interrupt is handled in the guest mode and the virtual host interrupt is handled in the virtual host mode 1 to n.

9. A hybrid virtualization method for an interrupt controller (IC) in a nested virtualization environment, the method comprising:
transferring a pending host interrupt to a host interrupt control register (HICR);
transferring a pending virtual guest interrupt to a guest interrupt control register (GICR) and setting a pending state of the virtual guest interrupt in a virtual interrupt configuration register (VICR);
transferring a pending virtual host interrupt to a virtual host interrupt control register (VHICR) and setting a pending state of the virtual host interrupt in the VICR;
generating a pending interrupt exception and signaling to a CPU (Central Processing Unit) if an interrupt exception privilege level of a CPU mode is higher than a current CPU mode; and
injecting, by a physical host or a virtual host, a virtual interrupt by setting the interrupt to pending state in the VICR.

10. A method for handling an interrupt in a nested virtualization environment, the method comprising:
running, by a physical hypervisor, at a highest privilege host mode 0 over a hardware machine; and
running, by a virtual hypervisor, on a virtual host mode 1 to n.
